(19) United States
(12) Patent Application Publication
(10) Pub. No.: US 2014/0261988 A1
(43) Pub. Date: Sep. 18, 2014

(54) REINFORCEMENT TO PREVENT TEARING AND PROVIDE STRUCTURAL SUPPORT AND MOISTURE ELIMINATION IN CORRUGATED PAPER BOARD

(71) Applicant: ADALIS CORPORATION, Vancouver, WA (US)

(72) Inventors: CYNTHIA A. STEWART-IRVIN, Battle Ground, WA (US); Justine Hanlon, Vancouver, WA (US)

(73) Assignee: ADALIS CORPORATION, VANCOUVER, WA (US)

(21) Appl. No.: 13/835,553

(22) Filed: Mar. 15, 2013

(51) Int. Cl. C09J 7/04; B31F 1/20; C09J 7/02

(52) U.S. Cl. CPC C09J 7/04; C09J 7/0264; B31F 1/20
USPC 156/210; 442/58; 428/343; 428/340; 428/337; 428/355 EN

(57) ABSTRACT

Embodiments of a reinforcing tape for preventing or minimizing structural instability of corrugated paper board that may be exposed to an aqueous liquid are disclosed. The reinforcing tape comprises (i) an extruded mesh substrate including a plurality of parallel thermoplastic polymer elements oriented in a first direction and a plurality of parallel thermoplastic polymer elements oriented in a second direction, wherein the thermoplastic polymer elements are spaced from 0.5 cm to 5 cm apart; and/or (ii) a nonwoven substrate comprising a plurality of randomly-oriented thermoplastic polymer fibrous elements. The reinforcing tape has a machine-direction trapezoidal tear strength of at least 2.3 kg. Embodiments of a method for using the reinforcing tape also are disclosed.

### FIELD

This disclosure concerns embodiments of a reinforcing tape for preventing or minimizing structural instability of corrugated paper board when exposed to an aqueous liquid, and methods of using the reinforcing tape.

### BACKGROUND

Containers made from corrugated paper board (e.g., bulk bins) are used to store products in the meat processing industry. It is common for internal contents (juices) to leak out of an interior plastic liner and saturate the bottom of the container. The moisture migrates through the corrugated medium and liners of the container's bottom flaps and wicks up the sidewalls, thereby weakening the container. The container may bulge and/or tear as it weakens, exposing the bin contents to contamination. Transportation vibration and/or impact can exacerbate the damage. If a single bin in a shipment is damaged, the whole shipment may be rejected.

### SUMMARY

Disclosed herein are embodiments of reinforcing tapes for preventing or minimizing structural instability of corrugated paper board that may be exposed to an aqueous liquid, as well as methods of making and using the reinforcing tape.

In some embodiments, a reinforcing tape includes a substrate comprising a mesh including a plurality of parallel thermoplastic polymer elements oriented in a first direction and a plurality of parallel thermoplastic polymer elements oriented in a second direction, and an adhesive; the reinforcing tape has a machine-direction trapezoidal tear strength of at least 2.3 kg. The substrate may have a width of at least 5 cm, and the thermoplastic polymer elements may be spaced from 0.5 cm to 5 cm apart. In some embodiments, the mesh is an extruded mesh. In some examples, the substrate has a basis weight of 24-150 g/m². The thermoplastic polymer elements may comprise polypropylene, polyethylene, polyester, polyamide, nylon, polyetheretherketone, or a combination thereof. In some embodiments, individual thermoplastic polymer elements have a break strength of at least 2.0 kg in any direction. In certain examples, intersections of the first plurality of thermoplastic polymer elements and the second plurality of thermoplastic polymer elements have a thickness less than twice an average thickness of individual polymer elements. In one embodiment, the substrate may further include a layer of randomly-oriented thermoplastic polymer fibrous elements adhered or fused to the mesh. Desirably, the reinforcing tape is non-wicking.

In some embodiments, the reinforcing tape includes a substrate comprising a plurality of randomly-oriented thermoplastic polymer fibrous elements, and an adhesive; the reinforcing tape has a width of at least 5 cm, and a machine-direction trapezoidal tear strength of at least 4 kg. The thermoplastic polymer fibrous elements may comprise polypropylene, polyethylene, polyester, polyamide, nylon, polyetheretherketone, or a combination thereof. In some embodiments, the substrate has a basis weight of 24-150 g/m² and/or a thickness of from 0.1 mm to 0.7 mm. The substrate may be porous to an aqueous liquid. Desirably, the reinforcing tape is non-wicking.

In any of the above embodiments, the adhesive may be a water-based adhesive, a hot-melt adhesive, a pressure-sensitive adhesive, least one component of a reactive adhesive, or any combination thereof. In some embodiments, the adhesive is a hot-melt adhesive comprising an ethylene-vinyl acetate copolymer and having a viscosity of at least 45,000 cP at 175° C. The adhesive may be disposed on at least a portion of a surface of the substrate. In certain examples, when the substrate is a mesh, the adhesive may be co-extruded with a thermoplastic polymer to produce thermoplastic polymer elements comprising the adhesive.

In any of the above embodiments, the reinforcing tape may further include one or more strength elements having a modulus of at least 30 GPa. The strength element may comprise a liquid crystal polymer, e.g., a high-modulus yarn. In some embodiments, the strength element is oriented lengthwise on the substrate.

In any of the above embodiments, the reinforcing tape may further include a quantity of a superabsorbent polymer having an initial volume and being capable of expanding up to 500 times the initial volume upon water absorption. The superabsorbent polymer may be a powder (i) embedded in at least a portion of the substrate, (ii) embedded in at least a portion of an adhesive disposed on the substrate, or (iii) embedded in at least a portion of the substrate and in at least a portion of an adhesive disposed on the substrate.

Embodiments of a method for preventing or minimizing structural instability of corrugated paper board that may be exposed to an aqueous liquid include adhesively affixing a reinforcing tape as described above internally within the corrugated paper board. The method may further include providing a liquid crystal polymer fibrous element, a superabsorbent polymer, or both a liquid crystal polymer fibrous element and a superabsorbent polymer within the corrugated paper board. In some embodiments, the corrugated paper board comprises at least a first layer, a second layer, and a fluted layer disposed between the first and second layers, and the reinforcing tape is adhesively affixed to an internal surface of at least one of the first layer and the second layer. An additional reinforcing tape may be affixed to an external surface of the corrugated paper board.

The foregoing will become more apparent from the following detailed description, which proceeds with reference to the accompanying figures.

### BRIEF DESCRIPTION OF THE DRAWINGS

FIG. 1 is a perspective view of a corrugated paper board substrate in which a reinforcing tape as disclosed herein is embedded.

FIGS. 2A and 2B illustrate two embodiments of a reinforcing tape comprising an extruded mesh.

FIG. 3 illustrates one embodiment of a reinforcing tape comprising a plurality of randomly-oriented polymer fibrous elements.

FIG. 4 illustrates one embodiment of a reinforcing tape comprising added fibers of a high-modulus yarn.

FIG. 5 illustrates on embodiment of a reinforcing tape including regions comprising a superabsorbent polymer.

FIG. 6 is a perspective view of a corrugated paper board container in which a reinforcing tape as disclosed herein is embedded.

### DETAILED DESCRIPTION

Corrugated paper board may become structurally unstable when exposed to aqueous liquids. For example, corrugated paper board containers can bulge and/or tear if the corrugated paper board becomes wet. Described below are embodiments of a reinforcing tape for preventing or minimizing structural instability of corrugated paper board that may be exposed to an aqueous liquid. Embodiments of a method for using the reinforcing tape also are disclosed.

As used herein, “comprising” means “including” and the singular forms “a” or “an” or “the” include plural references unless the context clearly dictates otherwise. The term “or” refers to a single element of stated alternative elements or a combination of two or more elements, unless the context clearly indicates otherwise.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Other features of the disclosure are apparent from the following detailed description and the claims.

Unless otherwise indicated, all numbers expressing width, thickness, strength, and so forth, as used in the specification or claims are to be understood as being modified by the term “about.” Unless otherwise indicated, non-numerical properties such as amorphous, continuous, crystalline, homogeneous, and so forth as used in the specification or claims are to be understood as being modified by the term “substantially,” meaning to a great extent or degree. Accordingly, unless otherwise indicated, implicitly or explicitly, the numerical parameters and/or non-numerical properties set forth are approximations that may depend on the desired properties sought, limits of detection under standard test conditions/methods, limitations of the processing method, and/or the nature of the parameter or property. When directly and explicitly distinguishing embodiments from discussed prior art, the embodiment numbers are not approximates unless the word “about” is recited.

### I. REINFORCING TAPE

Generally, the reinforcing tape can be applied to corrugated paper board during manufacture of the substrate. FIG. 1 illustrates one embodiment of a reinforcing tape 1 disposed between a corrugated flute member 2 and a liner 3. Alternatively, the tape can be applied to the corrugated paper board after manufacture. For example, the tape may be applied to an interior or exterior surface of a corrugated paper board container after the container has been formed or folded and glued into a finished container.

A reinforcing tape typically is applied to corrugated paper board to reinforce an end product (e.g., a formed or finished container or box). In this context, a reinforcing tape differs from a package sealing tape that is used only to seal the opening, panels, or flaps of a container or box.

In some examples, a reinforcing tape is applied to one or more side walls of a container, such as a bulk bin. In certain embodiments, the reinforcing tape is applied to a bin to prevent or minimize structural instability that occurs when liquid-containing contents within the bin leak. Because moisture damage typically occurs in a lower portion of the bin, the tape may be applied to a lower portion of the bin, such as to a lower portion of the side wall(s).

Embodiments of the disclosed reinforcing tape have a width of at least 5 cm, such as ≧15 cm, or ≧20 cm. In some examples, the reinforcing tape has a width of 15-30 cm, such as a width of 15 cm or 25 cm. The tape may be provided in discrete lengths or as a roll.

The reinforcing tape comprises a substrate having sufficient tensile strength, trapezoidal tear resistance, and energy absorption characteristics to prevent or minimize structural instability of corrugated paper board exposed to an aqueous liquid. In some embodiments, the reinforcing tape substrate has omnidirectional strength. In other words, the reinforcing tape exhibits longitudinal strength, crosswise strength, and/or diagonal strength directionally relative to a length of the tape. Desirably, the reinforcing tape substrate is substantially nonwicking when exposed to an aqueous liquid.

In some embodiments, the reinforcing tape substrate has a basis weight of 24-150 g/m², such as 24-100 g/m². The reinforcing tape substrate may have an average MD (machine direction) and/or XD (cross direction) trapezoidal tear strength of at least 2.3 kg (5 lbf or 22.2 N), such as at least 3 kg, or at least 4 kg. Machine direction refers to a lengthwise direction of the tape substrate. The MD and XD tear strengths may differ from one another. In some embodiments, the reinforcing tape substrate, as determined by a grab break test, has a MD maximum load (5 cm) of at least 9 kg (20 lbf or 89 N), preferably at least 15 kg, and/or an XD maximum load (5 cm) of at least 7.5 kg (16.5 lbf or 73.4 N), such as at least 10 kg.

In some embodiments, the reinforcing tape substrate comprises a mesh having a first plurality of parallel elements oriented in a first direction and a second plurality of parallel elements oriented in a second direction. In some embodiments, the parallel elements are thermoplastic polymer elements. Suitable polymers include polypropylene, polyethylene, polyester, polyamide, nylon, polyetheretherketone, or any other extrudable polymer material, and combinations thereof. Other materials suitable for use as parallel elements include, but are not limited, to high-modulus yarns (e.g., having a modulus of at least 30 GPa), natural fibers (e.g., cellulosic fibers, such as jute, cotton, ramie, flax, hemp, sisal, and bagasse), and other non-thermoplastic polymeric fibers (e.g., carbon fibers, and phenol-formaldehyde fibers). In some examples, the mesh is an extruded mesh.

In one embodiment, the reinforcing tape substrate 10 comprises parallel elements 11 oriented lengthwise and crosswise as illustrated in FIG. 2A. In another embodiment, parallel elements 21 are oriented in a first diagonal direction and a second diagonal direction relative to a length of a tape substrate 20 as shown in FIG. 2B. Although the illustrated embodiments show the first plurality of parallel elements and the second plurality of parallel elements oriented substantially perpendicular to one another, it is to be understood that the first and second pluralities of parallel elements may intersect one another at any angle.

Desirably, parallel elements 11, 21 are spaced sufficiently far apart that the mesh is non-wicking and does not facilitate migration of moisture through the corrugated paper board. However, parallel elements 11, 21 are spaced sufficiently close to one another to provide strength to the reinforcing tape substrate. Thus, in some embodiments, parallel elements 11, 21 typically are spaced an average of from 0.5 cm to 5 cm apart, such as an average of 1.0 cm to 1.5 cm apart. As the strength and/or denier of the individual elements increases, the parallel elements may be spaced farther apart. Individual elements may have a break strength (as measured in the weakest direction) of at least 2 kg, preferably at least 3 kg, or at least 4.8 kg.

In some embodiments, the mesh has multidirectional strength, i.e., the mesh exhibits longitudinal strength, crosswise strength, and/or diagonal strength directionally relative to a length of the tape. The mesh also resists longitudinal, crosswise, and/or diagonal tearing. In some examples, the mesh has an MD and/or XD trapezoidal tear strength of at least 2.3 kg, preferably at least 5.0 kg. The mesh also may have a grab break MD maximum load (5 cm) of at least 15 kg (146.8 N or 33 lbf), preferably at least 18 kg or at least 20.4 kg, and/or a grab break XD maximum load (5 cm) of at least 10 kg (97.9 N or 22 lbf), preferably at least 20 kg. The MD energy at break may be at least 2.0 J, preferably at least 3.0 J or at least 3.2 J.

The mesh may be calendered to flatten and/or smooth intersections where individual elements cross one another, thereby reducing variations in thickness, minimizing abrasiveness of the reinforced tape, and providing a flatter surface for adhesion. Prior to calendering, the intersections may have a thickness 2-3× greater than the thickness of individual elements. In some embodiments, the mesh has intersections after calendering that are less than twice the average thickness of individual elements.

In some embodiments, as shown in FIG. 3, the reinforcing tape substrate 30 comprises a plurality of randomly-oriented fibrous elements 31, e.g., a nonwoven fabric. In some embodiments, the fibrous elements are thermoplastic polymer fibrous elements. Suitable polymers include, but are not limited to, polypropylene, polyester, polyethylene, polyamide, nylon, polyetheretherketone, aromatic liquid crystal polymers, and combinations thereof. Other materials suitable for use as fibrous elements include, but are not limited, to high-modulus yarns (e.g., having a modulus of at least 30 GPa), natural fibers (e.g., cellulosic fibers, such as jute, cotton, ramie, flax, hemp, sisal, and bagasse), and other non-thermoplastic polymeric fibers (e.g., carbon fibers, and phenol-formaldehyde fibers). The substrate may have a thickness of from 0.1 mm to 1 mm, such as from 0.1 mm to 0.7 mm, 0.2 mm to 0.5 mm, or 0.2 mm to 0.35 mm.

The nonwoven substrate may be a spunbonded nonwoven fabric. Desirably, the substrate is porous to aqueous liquids. In one embodiment, the substrate is Typar® spunbond polypropylene nonwoven fabric (Fiberweb, Inc., Tennessee). Typar® fabric comprises polypropylene fibers with substantially consistent fiber diameters. In another embodiment, the substrate is Reemay® spunbond polyester nonwoven fabric (Fiberweb, Inc., Tennessee). Reemay® fabric comprises continuous trilobal polyester fibers having substantially consistent fiber diameters. In another embodiment, the nonwoven substrate comprises entangled microfilaments of polyester and polyamide, e.g., Evolon®, (Freudenberg Evolon, Colmar, France). In yet another embodiment, the nonwoven substrate is a polyarylate liquid crystal polymer such as Vecrus® (Kuraray Co., Ltd., Japan).

In some embodiments, the nonwoven substrate has multidirectional strength, i.e., the mesh exhibits longitudinal strength, crosswise strength, and/or diagonal strength in relative to a length of the tape. The nonwoven substrate also resists longitudinal, crosswise, and/or diagonal tearing. In some examples, the nonwoven substrate has an MD trapezoidal tear strength of at least 4 kg (40 N or 9 lbf), preferably at least 5 kg or at least 7.7 kg, and an XD trapezoidal tear strength of at least 3.4 kg (33.4 N or 7.5 lbf), such as at least 5.9 kg or at least 7.7 kg. The nonwoven substrate may have a grab break MD maximum load (5 cm) of at least 9.1 kg (89 N or 20 lbf), preferably at least 15.9 kg or at least 22.7 kg, and/or an XD maximum load (5 cm) of at least 7.5 kg (73.4 N or 16.5 lbf), preferably at least 7 kg, or at least 10 kg. The MD energy at break may be at least 1.5 J, preferably at least 3.7 J or at least 7.5 J.

In some embodiments, the substrate comprises a mesh and a plurality of randomly-oriented thermoplastic polymer fibrous elements, such as a nonwoven fabric as described above. The mesh and nonwoven fabric may be joined with an adhesive, or they may be fused together by heat or ultrasonic welding (e.g., point bonding).

In some embodiments, the reinforcing tape further comprises an adhesive. Suitable adhesives include, but are not limited to, a water-based adhesive, a hot-melt adhesive (including, but not limited to, a heat activatable hot melt adhesive, a hot melt pressure sensitive adhesive, a water dispersible hot melt adhesive, a biodegradable hot melt adhesive or a repulpable hot melt adhesive), a pressure-sensitive adhesive, a reactive adhesive (e.g., an adhesive that hardens by mixing two or more components, which chemically react), or any combination thereof. In one embodiment, the adhesive is moisture resistant. In another embodiment, the adhesive is a moisture-absorbent adhesive. Examples of typical hot melt adhesives include an ethylene-vinyl acetate copolymer (EVA-based) hot melt adhesive; EMA-based hot melt adhesive (ethylene methylacrylate); EnBA-based hot melt adhesive (ethylene n-butyl acrylate); hot melt adhesive based on polyamides; hot melt adhesives based on polyethylene and polypropylene homopolymers, copolymers and interpolymers, rubbery block copolymer hot melt adhesives; or adhesives activated by various means such as RF (radio frequency) activatable adhesives or ultrasonic-activated adhesives.

The adhesive can be applied to the reinforcing tape substrate by any suitable means, such as printing, dipping, roll coating, spraying, spreading with a doctor blade, laminating, or slot coating. The adhesive is applied to at least a portion of an upper or lower surface of the substrate. In some embodiments, the adhesive is applied to substantially the entire upper or lower surface of the substrate. In certain embodiments, the adhesive is applied to both an upper surface and a lower surface of the substrate. In some examples, the adhesive is coextruded with a thermoplastic polymer to form thermoplastic polymer elements for a mesh or to form thermoplastic polymer fibrous elements for a nonwoven substrate. In such embodiments, the thermoplastic polymer elements or thermoplastic polymer fibrous elements comprise the thermoplastic polymer and the adhesive.

The adhesive may be included in any amount effective to adhesively affix the reinforcing tape to corrugated paper board. In some embodiments, the reinforcing tape includes from 20-250 g/m² adhesive, such as from 20-200 g/m², 20-125 g/m², or 20-50 g/m².

Adhesive properties may be selected, at least in part, based upon the desired method of applying the adhesive. For examples, a person of ordinary skill in the art understands that spray-coating may utilize a lower-viscosity adhesive than an adhesive suitable for printing or for co-extrusion with a thermoplastic polymer. In some embodiments, the adhesive is an EVA-based hot-melt adhesive with a viscosity ≧45,000 cP at 175° C. (as measured by ASTM 1084-08 Method B), such as a viscosity of 45,000-60,000 cP. A high viscosity enables the adhesive to be co-extruded with a thermoplastic polymer when making an extruded mesh reinforcing tape substrate. The EVA-based adhesive may further comprise a rosin ester, aliphatic C5/C9 resins, styrene-isoprene-styrene (SIS)/rubber, a low melt point (e.g., <100° C.) wax, an antioxidant, and combinations thereof. Suitable antioxidants include type I primary antioxidants or combinations of a type II secondary antioxidant in conjunction with a type I primary antioxidant. The EVA desirably has a high molecular weight and low melt flow index grade, e.g., a melt flow index range from 5 to 10 as measured according to ASTM D1238. In some examples, the EVA comprises 25-30% vinyl acetate. The wax may be a Fischer-Tropsch wax with a narrow melt point range, such as a melting point range of <20° C., <15° C., or <10° C. In certain embodiments, the adhesive composition is selected to provide an adhesive that is flowable when sufficiently heated, but has sufficient viscosity to facilitate extrusion.

In one example, the adhesive included 42 wt % EVA (28% vinyl acetate), 36 wt % rosin ester, 8 wt % aliphatic C5/C9 resins, 8 wt % SIS/rubber (14% SIS, 84% rubber), 5.67 wt % Fischer Tropsch wax with a melt point of 88° C. (190° F.), and 0.33 wt % antioxidant. The adhesive properties are shown below in Table 1.

TABLE 1

| | | |
|---|---|---|
| Lab Softening Point | 94.8° C. | (202.6° F.) |
| Tack Point | 75.6° C. | (168° F.) |
| Softening Point/Tack Point Delta | 19.2° C. | (34.6° F.) |
| Peel | 53.6° C. | (128.5° F.) |
| Shear | 79.2° C. | (174.5° F.) |

| | |
|---|---|
| Viscosity | 48,700 cP* |
| Elongation | 1,316% |
| HM Strength | 6.92 MPa (1,004 psi) |
| Odor | ok |
| Color | ok |
| Green Tack Test | very strong, viscous |
| Bonds to Paper | yes |
| Bonds to Film | yes |

*measured at 177° C. (350° F.) according to ASTM 1084-08 Method B with a Brookfield Thermocel DV-E calibrated viscometer

In certain embodiments, the reinforcing tape further comprises one or more additional strength elements and/or an absorbent material. For example, the reinforcing tape may include one or more high-modulus yarns to provide additional strength by providing targeted structural support to the reinforcing tape and the corrugated paper board to which the tape is applied. Desirably the strength element has a modulus of at least 30 GPa, such as at least 50 GPa. In certain examples, the strength element has a modulus of 70-80 GPa. Suitable strength elements include, but are not limited to, high-modulus yarns of liquid crystal polymers such as Vectran® (Kuraray Co., Ltd., Japan). Vectran® is an aromatic polyester polymer produced by the polycondensation of 4-hydroxybenzoic acid and 6-hydroxynaphthalene-2-carboxylic acid. Strength elements may be incorporated into the substrate and/or an adhesive layer disposed on the substrate. The strength elements may be incorporated throughout the reinforcing tape. Alternatively, one or more strength elements may be oriented lengthwise on the reinforcing tape. A plurality of lengthwise strength elements 41 (e.g., high-modulus yarn fibers), for example, may be spaced at intervals across the width of a reinforcing tape 40 (FIG. 4). Alternatively, a plurality of crosswise or diagonal strength elements (not shown) may be spaced at intervals along the length of the reinforcing tape.

Other fibers that may be added to the reinforcing tape as strength elements include, but are not limited to, nylon, aramid fiber (e.g., DuPont™ Kevlar®), jute, linen, cotton, rayon, PEEK (polyetheretherketone), and combinations thereof. In some embodiments, nonwicking fibers are used to reduce the transport of moisture, which may further degrade the corrugated paper board structure. Most natural fibers transport moisture; however, fiber and/or fabric treatments may be used to lessen this tendency.

When the reinforcing tape is intended for use in corrugated paper board that may be exposed to aqueous liquids, the reinforcing tape may further comprise an absorbent material. Desirably, the absorbent is a superabsorbent polymer, i.e., a polymer that absorbs and retains large amounts of a liquid. A superabsorbent polymer is capable of absorbing up to 500 times its own weight of water. Superabsorbent polymers absorb aqueous solutions by hydrogen bonding with water molecules. Addition of a superabsorbent can slow and/or reduce the saturation of liquid into the corrugated paper board. The superabsorbent polymer may swell and/or form a gel as liquid is absorbed. For example, the superabsorbent polymer may expand up to 500× its initial volume as water is absorbed, such as from 30× to 500× its initial volume. As the superabsorbent polymer expands, it can block liquid from wicking past it. Suitable superabsorbent polymers include, but are not limited to, sodium polyacrylate, polyacrylamide copolymer, ethylene maleic anhydride copolymer, polyvinyl alcohol copolymer, crosslinked carboxymethylcellulose, crosslinked polyethylene oxide, starch-grafted copolymer of polyacrylonitrile, and combinations thereof.

In some embodiments, the superabsorbent polymer is a powder that is embedded in at least a portion of the reinforcing tape substrate and/or at least a portion of an adhesive disposed on the reinforcing tape substrate. The superabsorbent polymer may be incorporated throughout the width and length of the reinforcing tape, or incorporated in only a portion of the tape. In one example, the powder is disposed in one or more lengthwise regions 51 having a width less than the width of a reinforcing tape 50 (FIG. 5). One of ordinary skill in the art will understand that the superabsorbent polymer powder may instead be disposed in regions extending across the width of the reinforcing tape (not shown).

### II. METHOD OF USING THE REINFORCING TAPE

Embodiments of the disclosed reinforcing tape are suitable for preventing or minimizing structural instability of corrugated paper board that may be exposed to an aqueous liquid. In some embodiments, the method includes adhesively affixing reinforcing tape internally within corrugated paper board during its manufacture. For example, the reinforcing tape 1 may be adhesively fixed between a corrugated flute member 2 and a liner 3 as shown in FIG. 1.

When the corrugated paper board is intended for use in a container, e.g., a bin, the reinforcing tape may be affixed to one or more areas of the corrugated paper board that may be exposed to an aqueous liquid. For example, the tape can be positioned so that it will be disposed in a lower portion of a container's side walls after the container has been constructed. FIG. 6 illustrates one embodiment of a corrugated paper board container 60 including a reinforcing tape 61 embedded in a lower portion of a side wall 62.

In some embodiments, the method further includes providing a liquid crystal polymer fibrous element, a superabsorbent polymer, or both a liquid crystal polymer fibrous element and a superabsorbent polymer within the corrugated paper board. The liquid crystal polymer fibrous element and/or superabsorbent polymer can be provided as components of the reinforcing tape or as separate components disposed within the corrugated paper board. As separate components, the liquid crystal polymer fibrous element and/or superabsorbent polymer may be positioned above the reinforcing tape, below the reinforcing tape, or both above and below the reinforcing tape.

In some applications, it may be advantageous to affix additional reinforcing tape to an external surface of the corrugated paper board to further reinforce the corrugated paper board. When the corrugated paper board is formed into a container (e.g., a bin), the additional reinforcing tape may be on an external surface or an internal surface of the container.

### III. METHODS OF MAKING THE REINFORCING TAPE

In one embodiment, reinforcing tape is produced by applying an adhesive to a mesh substrate. The mesh may be formed by extruding a thermoplastic polymer to form an extruded mesh substrate comprising a plurality of parallel thermoplastic polymer elements oriented in a first direction and a plurality of parallel thermoplastic polymer elements oriented in a second direction. The mesh substrate subsequently may be calendered to reduce its thickness at intersections of the polymer elements. Adhesive is applied to the mesh substrate by any suitable means including, but not limited to, printing, dipping, roll coating, spraying, spreading with a doctor blade, laminating, or slot coating. Adhesive is applied to at least a portion of an upper surface and/or a lower surface of the mesh substrate. In some examples, adhesive is applied to the entire upper surface and/or lower surface of the mesh substrate. Alternatively, an adhesive composition may be coextruded with the thermoplastic polymer, thereby forming polymer elements comprising the thermoplastic polymer and the adhesive.

In another embodiment, reinforcing tape is produced by applying an adhesive to a substrate comprising a plurality of randomly-oriented thermoplastic fibrous elements. The adhesive is applied to the substrate by any suitable means including, but not limited to, printing, dipping, roll coating, spraying, spreading with a doctor blade, laminating, or point bonding. Adhesive is applied to at least a portion of an upper surface and/or a lower surface of the substrate. In some examples, adhesive is applied to the entire upper surface and/or lower surface of the substrate.

In another embodiment, a reinforcing tape substrate is produced by combining a mesh and a nonwoven fabric. The mesh and nonwoven fabric may be adhesively combined, or they may be fused together by heat or ultrasonic welding (e.g., point bonding). An adhesive is then applied to the substrate by any suitable means including, but not limited to, printing, dipping, roll coating, spraying, spreading with a doctor blade, laminating, or point bonding. Adhesive is applied to at least a portion of an upper surface and/or a lower surface of the substrate. In some examples, adhesive is applied to the entire upper surface and/or lower surface of the substrate.

In any of the above embodiments, additional strength elements, such as a high-modulus yarn or other strengthening fibers, may be added to the reinforcing tape. In one example, the strength elements are applied to the reinforcing tape after application of an adhesive to the substrate and before the adhesive has completely dried, thereby embedding the strength elements at least partially in the adhesive. In another example, the strength elements are disposed on the substrate before adhesive applied. In yet another embodiment, the strength elements are embedded within a nonwoven substrate.

In any of the above embodiments, a superabsorbent polymer (e.g., a superabsorbent polymer powder) may be added to the reinforcing tape. In one example, the superabsorbent polymer is embedded in the substrate. For example, particles of a superabsorbent particle can be disposed between two thin layers of a wet-laid nonwoven material. In another example, the superabsorbent polymer is disposed on the substrate before applying adhesive. In yet another example, the superabsorbent polymer is mixed into the adhesive and applied with the adhesive. In still another example, the superabsorbent polymer is applied to the reinforcing tape after application of an adhesive to the substrate and before the adhesive has completely dried, thereby embedding particles of the superabsorbent polymer at least partially in the adhesive. In another example, the superabsorbent polymer is disposed on the substrate in an alternating pattern or other pattern with a hot-melt adhesive by slot coating, printing, or other suitable means.

In any of the above embodiments, the reinforcing tape may be cut into desired lengths based upon the intended end use. Alternatively, the reinforcing tape may be wound onto a roll for future use.

### IV. EXAMPLES

### Example 1

### Strength and Leak Testing

Reinforcing tape substrates included five nonwoven substrates (A (polyethylene terephthalate (PET), 136 g/m²), B (PET, 79.9 g/m²), C (PET, 45.9 g/m²), D (PET, 34 g/m²), and E (polypropylene, 42.5 g/m²)), and two extruded polypropylene mesh substrates (“F and G), each with a polypropylene core having a basis weight of 24.4 g/m². Substrate “F” had 2 polymer elements per inch (1.25-cm spacing), and substrate “G” had 2.5 polymer elements per inch (1-cm spacing).

All of the substrates included adhesive. The adhesives varied in viscosity. It is noted, however, that the adhesives do not significantly affect the tested properties of the reinforcing tapes. Samples “C” and “D” included a hot-melt adhesive comprising 55 wt % sodium polyacrylate superabsorbent polymer (SAP); the adhesive was added in a 10-cm strip down the center of the substrate in an amount of 24 g/m². Sample “G” included an adhesive comprising 42 wt % EVA (28% vinyl acetate), 36 wt % rosin ester, 8 wt % aliphatic C5/C9 resins, 8 wt % SIS/rubber (14% SIS, 84% rubber), 5.67 wt % Fischer Tropsch wax with a melt point of 88° C. (190° F.), and 0.33 wt % antioxidant with the properties shown in Table 1. The adhesive had a coat weight of 7.3-8.8 g/m².

For the grab break test, the specimen was centered in the 2-inch (5-cm) wide jaws of an Instron® tensile tester (Instron, Norwood, Mass.). The gauge length was 4 inches (10 cm), and the rate of speed was 12 inches (30.5 cm) per minute. Failure was initially defined as the load dropping by 20%, but subsequently was increased to 40% and then 90% as the reinforcing tapes remained intact.

A trapezoidal tear test was performed for the reinforcing tape specimens. A 4 inch×6 inch (10.2 cm×15.2 cm) wide sample was mounted in the grips of the test machine from the edges. A small cut to initiate tear was placed in the middle of the mounted specimen. The sample was pulled at 12 inches (30.5 cm) per minute to tear in the direction indicated (MD—tears in machine direction, XD—tears in cross-machine direction). Maximum force was recorded.

Impact testing was performed on double wall 13″×13″×13″ (33 cm×33 cm×33 cm) regular slotted containers (RSCs) (48 lbs/in (8.6 kg/cm) ECT rating) containing 120 pounds (54.5 kg) of a non-newtonian liquid viscoelastic polymer (e.g., “flubber,” a polymer of hydrated borate and PVA). The box (constructed) bottoms were first soaked in a 2.5-cm deep bath of water, loaded, and tested. The ISTA (International Safe Transit Association) 1A test method was used to vibrate the loaded boxes in the Z-axis at 4.25 Hz with a 1.25 inch (3.2 cm) amplitude. Failure is defined as contents in the container becoming exposed (i.e., breaching, or bulging outside, the box) within 10 minutes. Passing is defined as no exposure of contents after 10 minutes.

The test results are shown in Tables 2A, 2B and 3. The nonwoven material “E” performed best overall. Substrate “E” was thin enough to not be noticeable in the corrugate. It passed the ISTA impact test. Because the fibers are laid multidirectional, the impact forces can be diverted away from a scoreline and prevent a zippering effect (tearing of scoreline through tape) when the paper failure rises above the tape. This tape is also non-abrasive and will not abrade the wet bin or inner bag as it becomes exposed.

Calendered netting of sufficient strength is the next most performance-desirable tape. The netting, if too weak and/or if the machine direction ends are too close, will zipper once the hydraulic pressure is too great on an edge of the tape. This can be overcome by positioning ends >0.84 cm apart with trapezoidal tear above 29 N (8.7 lbf). Calendering the tape provides a smoother non-abrasive surface. It passed the ISTA Z-axis testing.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

TABLE 2A

| Sample | Control 1 | Control 2 | A | B | C |
|---|---|---|---|---|---|
| Description | No reinforcement | Sesame | nonwoven, | nonwoven, | nonwoven, |
| | | tape alone | PET | PET | PET w/ |
| | | | | | SAP |
| Adhesive | | Hot-melt | Hot-melt | Hot-melt | Hot-melt |
| MD Max Load/5 cm | | 34 kg | 47.6 | 38.7 | 15.1 |
| Grab Break (kg) | | per 11 mm | | | |
| | | width | | | |
| XD Max Load/5 cm | | <0.7 | 33.0 | | 10.5 |
| Grab Break (kg) | | | | | |
| Strands subjected to Grab | | 1 | na | na | na |
| Break test | | | | | |
| Strength per strand | | <0.7 | na | na | na |
| (weakest direction) (kg) | | | | | |
| MD energy @ break (J) | | | 13.0 | 9.7 | 1.68 |
| XD energy @ break (J) | | 0.018 | 12.6 | | 1.5 |
| MD trapezoidal/tongue | | 34 | 16.0 | | 4.6 |
| tear (kg) | | | | | |
| XD trapezoidal/tongue | | <0.7 | 25.5 | | 6.5 |
| tear (kg) | | | | | |
| Wicking | | no | no | no | no |

TABLE 2B

| | | | | | D and G |
|---|---|---|---|---|---|
| Sample | D | E | F | G | combined |
| Description | nonwoven, | nonwoven, | mesh, | mesh, | nonwoven PET |
| | PET w/ | polypropylene | polypropylene | polypropylene | and |
| | SAP | | | | polypropylene |
| | | | | | w/o SAP |
| Adhesive | Hot-melt | Hot-melt | Hot-melt | Hot-melt | Hot-melt |
| MD Max Load/5 cm | 13.0 | 25.6 | 19.5 | 16.2 | |
| Grab Break (kg) | | | | | |
| XD Max Load/5 cm | 7.5 | 11.7 | 12 | 24.5 | |
| Grab Break (kg) | | | | | |
| Strands subjected to | na | na | 4 | 5 | |
| Grab Break test | | | | | |
| Strength per strand | na | na | 3.08 | 3.25 | |
| (weakest direction) | | | | | |
| (kg) | | | | | |
| MD energy @ break | 3.0 | 8.3 | 3.33 | 3.91 | |
| (J) | | | | | |
| XD energy @ break | 2.0 | 7.8 | 1.20 | 4.41 | |
| (J) | | | | | |
| MD | 5.6 | 8.12 | 5.08 | 3.86 | |
| trapezoidal/tongue | | | | | |
| tear (kg) | | | | | |
| XD | 6.3 | 7.98 | 4.31 | 6.03 | |
| trapezoidal/tongue | | | | | |
| tear (kg) | | | | | |
| Wicking | no | no | no | no | |

TABLE 3
ITSA 1A (Z-axis 4.25 hz 1.25″ test on RSC's)

| | |
|---|---|
| Control 1 | Fails catastrophically @ 1036 cycles (4 min 4 sec) |
| | at vertical score by mfg. Other corners torn 1″ as well. Failure |
| | starts at corner and migrates up. |
| Control 2 | Not tested |
| A | Pass-Non visible damage at 2777 cycles (10 min) |
| B | Not tested |
| C | Pass-Sample with moisture absorbent had minimal moisture |
| | wicking and bottom of box not saturated after test. No visible |
| | tearing at 2250 cycles (10 min) |
| D | Not tested |
| E | Pass-At 2552 cycles (10 min), still containing product. |
| | Moisture wicking and outer liner tear visible 3 inches up |
| | scorelines. Reinforcement in perfect condition. |
| F | Pass-Still containing product at 2436 cycles (10 minutes). |
| | Vertical scorelines wet. One corner's corrugate appears torn |
| | to top of tape. No damage to reinforcement. |
| G | Failed at 1936 cycles (7 min 45 sec) in one corner. The |
| | corrugate and net reinforcement tore enough to allow |
| | contents to flow out. |
| D and G | Pass-Lasted 10 minutes with just a 1 cm tear at the base |
| combined | of a vertical scoreline. |

We claim:

1. A reinforcing tape, comprising:
a substrate comprising a mesh including a plurality of parallel thermoplastic polymer elements oriented in a first direction and a plurality of parallel thermoplastic polymer elements oriented in a second direction, and wherein the reinforcing tape has a machine-direction trapezoidal tear strength of at least 2.3 kg; and
an adhesive.

2. The reinforcing tape of claim 1, wherein the substrate has a width of at least 5 cm.

3. The reinforcing tape of claim 1, wherein the thermoplastic polymer elements are spaced from 0.5 cm to 5 cm apart.

4. The reinforcing tape of claim 1, wherein the thermoplastic polymer elements comprise polypropylene, polyethylene, polyester, polyamide, nylon, polyetheretherketone, or a combination thereof.

5. The reinforcing tape of claim 1, wherein individual thermoplastic polymer elements have a break strength of at least 2.0 kg in any direction.

6. The reinforcing tape of claim 1, wherein the mesh is an extruded mesh.

7. The reinforcing tape of claim 1, wherein the substrate has a basis weight of 24-150 g/m².

8. The reinforcing tape of claim 1, wherein intersections of the first plurality of thermoplastic polymer elements and the second plurality of thermoplastic polymer elements have a thickness less than twice an average thickness of individual polymer elements.

9. The reinforcing tape of claim 1, wherein the adhesive is a water-based adhesive, a hot-melt adhesive, a pressure-sensitive adhesive, least one component of a reactive adhesive, or any combination thereof.

10. The reinforcing tape of claim 1, wherein the adhesive is a hot-melt adhesive comprising an ethylene-vinyl acetate copolymer and having a viscosity of at least 45,000 cP at 175° C.

11. The reinforcing tape of claim 1, wherein the adhesive is coextruded with a thermoplastic polymer to produce thermoplastic polymer elements comprising the adhesive.

12. The reinforcing tape of claim 1, wherein the adhesive is disposed on at least a portion of a surface of the substrate.

13. The reinforcing tape of claim 1, further comprising one or more strength elements having a modulus of at least 30 GPa.

14. The reinforcing tape of claim 13, wherein the strength element comprises a liquid crystal polymer.

15. The reinforcing tape of claim 13, wherein the strength element is oriented lengthwise on the substrate.

16. The reinforcing tape of claim 1, further comprising a quantity of a superabsorbent polymer having an initial volume and being capable of expanding up to 500 times the initial volume upon water absorption.

17. The reinforcing tape of claim 16, wherein the superabsorbent polymer is a powder (i) embedded in at least a portion of the substrate, (ii) embedded in at least a portion of an adhesive disposed on the substrate, or (iii) embedded in at least a portion of the substrate and in at least a portion of an adhesive disposed on the substrate.

18. The reinforcing tape of claim 1, wherein the reinforcing tape is non-wicking.

19. The reinforcing tape of claim 1, wherein the substrate further comprises a layer of randomly-oriented thermoplastic polymer fibrous elements adhered or fused to the mesh.

20. A reinforcing tape, comprising:
a substrate comprising a plurality of randomly-oriented thermoplastic polymer fibrous elements; and
an adhesive adhered to the substrate, wherein the reinforcing tape has a width of at least 5 cm, and a machine-direction trapezoidal tear strength of at least 4 kg.

21. The reinforcing tape of claim 20, wherein the thermoplastic polymer fibrous elements comprise polypropylene, polyethylene, polyester, polyamide, nylon, polyetheretherketone, or a combination thereof.

22. The reinforcing tape of claim 21, wherein the substrate has a basis weight of 24-150 g/m².

23. The reinforcing tape of claim 20, wherein the substrate has a thickness of from 0.1 mm to 1 mm.

24. The reinforcing tape of claim 20, wherein the adhesive is a water-based adhesive, a hot-melt adhesive, a pressure-sensitive adhesive, least one component of a reactive adhesive, or any combination thereof.

25. The reinforcing tape of claim 20, wherein the adhesive is a hot-melt adhesive comprising an ethylene-vinyl acetate copolymer and having a viscosity of at least 45,000 cP at 175° C.

26. The reinforcing tape of claim 20, wherein the substrate is porous to an aqueous liquid.

27. The reinforcing tape of claim 20, further comprising one or more strength elements having a modulus of at least 30 GPa.

28. The reinforcing tape of claim 27, wherein the strength element comprises a liquid crystal polymer.

29. The reinforcing tape of claim 27, wherein the strength element is oriented lengthwise on the substrate.

30. The reinforcing tape of claim 20, further comprising a quantity of a superabsorbent polymer having an initial volume and being capable of expanding up to 500 times the initial volume upon water absorption.

31. The reinforcing tape of claim 30, wherein the superabsorbent polymer is a powder (i) embedded in at least a portion of the substrate, (ii) embedded in at least a portion of an adhesive disposed on the substrate, or (iii) embedded in at least a portion of the substrate and in at least a portion of an adhesive disposed on the substrate.

32. The reinforcing tape of claim 20, wherein the reinforcing tape is non-wicking.

33. A method for preventing or minimizing structural instability of corrugated paper board that may be exposed to an aqueous liquid, the method comprising:
adhesively affixing a reinforcing tape according to claim 1 internally within the corrugated paper board.

34. The method of claim 33, further comprising providing a liquid crystal polymer fibrous element, a superabsorbent polymer, or both a liquid crystal polymer fibrous element and a superabsorbent polymer within the corrugated paper board.

35. The method of claim 33, wherein the corrugated paper board comprises at least a first layer, a second layer, and a fluted layer disposed between the first and second layers, and wherein the reinforcing tape is adhesively affixed to an internal surface of at least one of the first layer and the second layer.

36. The method of claim 33, further comprising affixing a reinforcing tape according to claim 1 to an external surface of the corrugated paper board.

37. A method for preventing or minimizing structural instability of corrugated paper board that may be exposed to an aqueous liquid, the method comprising:
adhesively affixing a reinforcing tape according to claim 20 internally within the corrugated paper board.

38. The method of claim 37, further comprising providing a liquid crystal polymer fibrous element, a superabsorbent polymer, or both a liquid crystal polymer fibrous element and a superabsorbent polymer within the corrugated paper board.

39. The method of claim 37, wherein the corrugated paper board comprises at least a first layer, a second layer, and a fluted layer disposed between the first and second layers, and wherein the reinforcing tape is adhesively affixed to an internal surface of at least one of the first layer and the second layer.

40. The method of claim 37, further comprising affixing a reinforcing tape according to claim 20 to an external surface of the corrugated paper board.
